(19) United States
(12) Patent Application Publication
(10) Pub. No.: US 2013/0230752 A1
(43) Pub. Date: Sep. 5, 2013

(54) SEALED BATTERY

(71) Applicant: HITACHI MAXELL, LTD, Osaka (JP)

(72) Inventors: Yoshihisa Fujihara, Ibaraki-shi (JP); Mayumi Yamamoto, Ibaraki-shi (JP); Hiroshi Maesono, Ibaraki-shi (JP); Hiroshi Abe, Ibaraki-shi (JP)

(73) Assignee: HITACHI MAXELL, LTD, Osaka (JP)

(21) Appl. No.: 13/780,696

(22) Filed: Feb. 28, 2013

(30) Foreign Application Priority Data
Mar. 1, 2012 (JP) 2012-045765

(51) Int. Cl. H01M 2/12

(52) U.S. Cl. CPC H01M 2/1235
USPC 429/82

(57) ABSTRACT

A sealed battery includes a battery case. A side of the battery case includes a cleavage groove forming a cleavage line intersecting a ridge line. The cleavage line is formed exclusively of a curved line having a first curved segment curved to protrude in one direction as viewed in a direction normal to the side of the battery case and a second curved segment curved to protrude in a direction forming an angle of 90 degrees or larger with the direction in which the first curved segment protrudes, the first and second curved segments being connected with each other. An end of the first curved segment is connected with an end of the second curved segment. At least one of the first curved segment and the second curved segment intersects the ridge line. The cleavage groove has a depth that produces a ratio of the remaining thickness relative to the plate thickness of the battery case of 75% or smaller.

### CROSS-REFERENCE TO RELATED APPLICATIONS

This application claims a priority from Japanese Patent Application No. 2012-45765, filed Mar. 1, 2012, which is incorporated herein by reference in its entirety.

### BACKGROUND

1. Technical Field

The present invention relates to a sealed battery having a cleavage groove formed on a side of a battery case encapsulating an electrode assembly and electrolyte, the cleavage groove configured to cleave up when the pressure in the battery case exceeds a threshold.

2. Description of the Background Art

Sealed batteries with a cleavage groove formed on a side of the battery case that is configured to cleave up when the pressure in the battery case exceeds a threshold are known. As disclosed in Japanese Patent No. 4166028, for example, such a sealed battery includes a cleavage groove located on a side of the battery case to intersect a raised ridge (i.e. a ridge line), which is formed when the battery case swells up due to an increase in internal pressure. When the pressure in the battery case exceeds a threshold, the battery case is deformed to cause the cleavage groove to cleave up. This releases gas or the like in the battery case to the outside.

### SUMMARY

If a cleavage groove is provided on a side of the battery case, as disclosed in Japanese Patent No. 4166028, the cleavage groove may cleave up from an impact to the battery case if the battery falls, for example. In such a case, electrolyte in the battery case may leak out.

In view of this, the cleavage line formed by the cleavage groove may be shaped such that the groove is unlikely to cleave up when the battery falls, for example. However, if a cleavage line is thus shaped, the cleavage groove may not cleave up even when the pressure in the battery case exceeds a threshold.

Further, the cleavage line is preferably shaped such that the cleavage groove opens up as widely as possible when cleaved in order to release gas effectively from within the battery case. However, if the area where a cleavage is generated is increased to form a relatively large opening, some cleaved portions may get in contact with the electrode assembly in the battery case to cause a short circuit, or may damage an exterior cladding film that covers the battery case.

In view of this, the cleavage line formed by the cleavage groove may be formed exclusively of a curved line made up of a first curved segment curved to protrude in one direction and a second curved segment curved to protrude in a direction forming an angle of 90 degrees or larger with the direction in which the first curved segment protrudes, the first and second curved segments being connected with each other. A cleavage line thus shaped allows the cleavage groove to cleave up safely and easily in response to a certain pressure in the battery case and, when cleaved, leaves a relatively large opening. Moreover, a cleavage groove forming a cleavage line in such a shape is not likely to cleave up from an impact if the battery falls.

However, batteries of different types have battery cases in different sizes and with different plate thicknesses. Consequently, even a cleavage line in the above described shape may not always allow the cleavage groove to cleave up in response to a certain pressure in the battery case.

In view of the above, an object of the present invention is to provide a sealed battery having a cleavage groove on a side of the battery case, the cleavage groove formed exclusively of a curved line made up of a first curved segment curved to protrude in one direction and a second curved segment curved to protrude in a direction forming an angle of 90 degrees or larger with the direction in which the first curved segment protrudes, the first and second curved segments being connected with each other, where the cleavage groove is configured to cleave up more reliably in response to a certain pressure in the battery case even with varying size and plate thickness of the battery case.

A sealed battery according to an embodiment includes a hollow and cylindrical battery case configured to encapsulate an electrode assembly and electrolyte. A side of the battery case includes a cleavage groove forming a cleavage line intersecting a ridge line which is formed on the side of the battery case when the battery case swells up due to an increase in internal pressure. The cleavage line is formed exclusively of a curved line and formed of a first curved segment curved to protrude in one direction as viewed in a direction normal to the side of the battery case and a second curved segment curved to protrude in a direction forming an angle of 90 degrees or larger with the direction in which the first curved segment protrudes, the first and second curved segments being connected with each other. An end of the first curved segment is connected with an end of the second curved segment. At least one of the first curved segment and the second curved segment intersects the ridge line. The cleavage groove has a depth that produces a ratio of a remaining thickness relative to a plate thickness of the battery case of 75% or smaller.

In the sealed battery according to an embodiment, a cleavage groove is formed on a side of the battery case, the cleavage groove formed exclusively of a curved line made up of a first curved segment curved to protrude in one direction and a second curved segment curved to protrude in a direction forming an angle of 90 degrees or larger with the direction in which the first curved segment protrudes, the first and second curved segments being connected with each other, where the depth of the cleavage groove is such that the remaining thickness ratio is 75% or smaller. This will allow the cleavage groove to cleave up in a more reliable manner in response to a certain pressure in the battery case even with varying plate thickness of the battery case.

### BRIEF DESCRIPTION OF THE DRAWINGS

FIG. 1 is a schematic perspective view of a sealed battery of an embodiment.

FIG. 2 is a cross-sectional view of the battery taken on line II-II of FIG. 1.

FIG. 3 is a schematic side view of the sealed battery of the embodiment.

FIG. 4 is a perspective view illustrating the sealed battery during venting.

FIG. 5 is a cross-sectional view of the battery case taken on line V-V of FIG. 4.

FIG. 6 illustrates part of a calculation model of an S-shaped cleavage groove.

FIG. 7 is a cross-sectional view of the battery case taken on line VII-VII of FIG. 6.

FIG. 8 is a graph showing the remaining thickness of the cleavage groove versus the venting pressure as obtained by calculation and by experiment.

FIG. 9 illustrates the remaining thickness ratio versus the venting pressure of the cleavage groove in different implementations where a cleavage groove is provided on a side of battery cases with different sizes.

FIG. 10 illustrates the location of a cleavage groove provided on a flat section of the battery case.

### DESCRIPTION OF THE EMBODIMENTS

A sealed battery according to an embodiment includes a hollow and cylindrical battery case configured to encapsulate an electrode assembly and electrolyte. A side of the battery case includes a cleavage groove forming a cleavage line intersecting a ridge line which is formed on the side of the battery case when the battery case swells up due to an increase in internal pressure. The cleavage line is formed exclusively of a curved line and formed of a first curved segment curved to protrude in one direction as viewed in a direction normal to the side of the battery case and a second curved segment curved to protrude in a direction forming an angle of 90 degrees or larger with the direction in which the first curved segment protrudes, the first and second curved segments being connected with each other. An end of the first curved segment is connected with an end of the second curved segment. At least one of the first curved segment and the second curved segment intersects the ridge line. The cleavage groove has a depth that produces a ratio of a remaining thickness relative to a plate thickness of the battery case of 75% or smaller (first arrangement).

In the above arrangement, the cleavage groove formed on a side of the battery case forms, as viewed in a direction normal to the side of the battery case, a cleavage line formed exclusively of a curved line made up of a first curved segment curved to protrude in one direction and a second curved segment curved to protrude in a direction forming an angle of 90 degrees or larger with the direction in which the first curved segment protrudes, the first and second curved segments being connected with each other. A cleavage groove forming a cleavage line thus shaped can cleave up safely and easily in response to a certain pressure in the battery case and, when cleaved, leaves a relatively large opening. Moreover, the cleavage groove is unlikely to cleave up from an impact if the battery falls, for example.

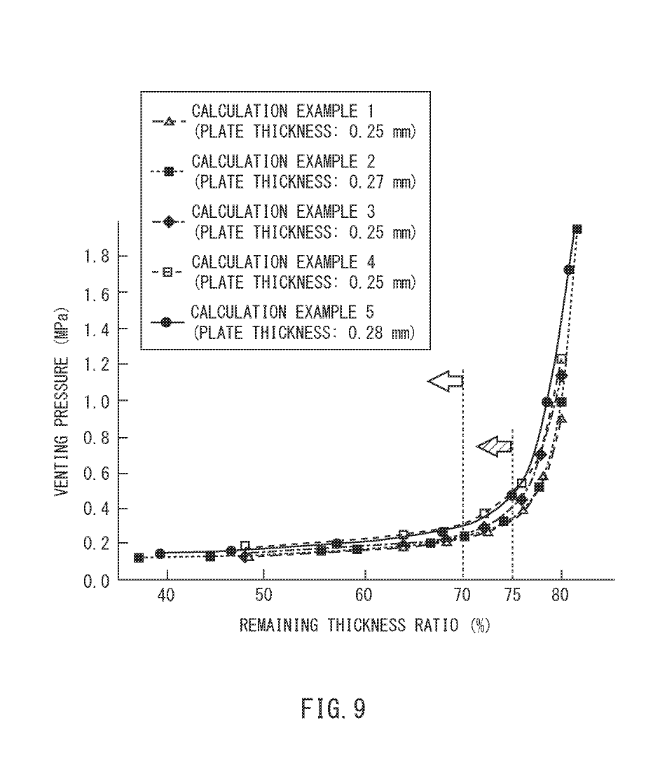

Further, the cleavage groove has a depth that produces a ratio of the remaining thickness relative to the plate thickness of the battery case (hereinafter referred to as “remaining thickness ratio”) of 75% or smaller. Thus, the cleavage groove can cleave up in response to a certain pressure in the battery case even with varying plate thickness of battery case. More specifically, as shown in FIG. 9, the amount of change in the venting pressure for the cleavage groove (i.e. the pressure threshold where the cleavage groove cleaves up) in a given range of remaining thickness ratio is smaller for remaining thickness ratios of 75% than for remaining thickness ratios of larger than 75%; thus, for remaining thickness ratios of 75% and smaller, the cleavage groove cleaves up when the pressure is near the design value of venting pressure even if the remaining thickness ratio is somewhat incorrect due to an error during machining or the like. As discussed above, as the depth of the cleavage groove is defined by the remaining thickness ratio, the cleavage groove can cleave up in a more reliable manner in response to a certain pressure in the battery case if the cleavage groove has a depth that produces a remaining thickness ratio of 75% or smaller, even with varying plate thickness of the battery case.

In the first arrangement above, the cleavage groove has a depth that produces a ratio of the remaining thickness relative to the plate thickness of the battery case of 70% or smaller (second arrangement).

As shown in FIG. 9, the amount of change in the venting pressure for the cleavage groove in a given range of remaining thickness ratio is smaller for remaining thickness ratios of 70% and smaller than for remaining thickness ratios in the range of 70% to 75%. Thus, for remaining thickness ratios of 70% and smaller, the cleavage groove cleaves up in a still more reliable manner when the pressure is near the design value of venting pressure than for remaining thickness ratios in the range of 70% to 75%, even if the remaining thickness ratio is somewhat incorrect.

In the first or second arrangement above, the cleavage line is formed of a combination of a single first curved segment and a single second curved segment (third arrangement). Thus, a cleavage groove forming a cleavage line in a simple shape (S-shape, for example) can cleave up more easily when the battery case is deformed and, after the cleavage groove cleaves up, a relatively large opening can be easily created.

In one of the first to third arrangements above, it is preferable that the first curved segment is curved to protrude toward a corner of the battery case located at a base end of the ridge line, and the cleavage groove is formed on the side of the battery case such that the first curved segment is located on the ridge line (fourth arrangement).

Thus, the protrusion of the first curved segment is located closer to the end of the battery case as measured on the ridge line. Thus, the first curved segment, which is located on the ridge line, can easily cleave up as the battery case is deformed. More specifically, as the battery case is deformed, a ridge line is generated beginning from the area near the end of the battery case. In view of this, having the first curved segment curved to protrude toward that end will allow the first curved segment to cleave up early during the deformation of the battery case. Thus, the cleavage groove can cleave up in a more reliable manner as the battery case is deformed.

In one of the first to fourth arrangements above, the cleavage groove is formed on the side of the battery case to be located in an area with a side of one half of a vertical dimension and a side of one half of a horizontal dimension of the battery case with a corner at a corner of the battery case located at a base end of the ridge line, as viewed in a direction normal to the side of the battery case (fifth arrangement).

This will allow the cleavage groove to be provided closer to the base end of a ridge line formed on the side of the battery case. Thus, the cleavage groove can cleave up in a more reliable manner as the side of the battery case is deformed due to a change in pressure in the battery case.

In one of the first to fourth arrangements above, the cleavage groove is formed on the side of the battery case to be located in an area with a side of one third of a vertical dimension and a side of one third of a horizontal dimension of the battery case with a corner at a corner of the battery case located at a base end of the ridge line, as viewed in a direction normal to the side of the battery case (sixth arrangement).

This will allow the cleavage groove to be provided still closer to the base end of a ridge line formed on the side of the battery case. Thus, the cleavage groove can cleave up in a still more reliable manner as the side of the battery case is deformed due to a change in pressure in the battery case.

Now, embodiments of the present invention will be described in detail with reference to the drawings. The dimensions of the components in the drawings do not exactly represent the dimensions of the actual components or the dimension ratios of the components.

(Overall Arrangement)

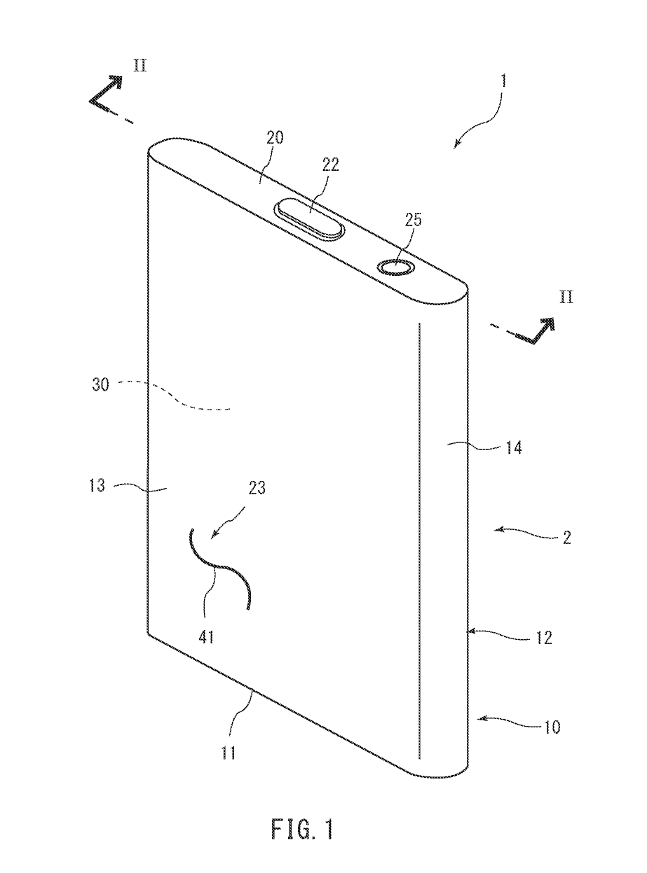

FIG. 1 is a schematic perspective view of a sealed battery 1 according to an embodiment. The sealed battery 1 includes: an exterior can 10 in the form of a cylinder with a bottom; a cap 20 that covers the opening of the exterior can 10; and an electrode assembly 30 contained in the exterior can 10. The exterior can 10 together with the attached cap 20 forms a hollow cylindrical battery case 2 with a space inside. It should be noted that, in addition to the electrode assembly 30, non-aqueous electrolyte (hereinafter referred to as “electrolyte”), is enclosed in the battery case 2.

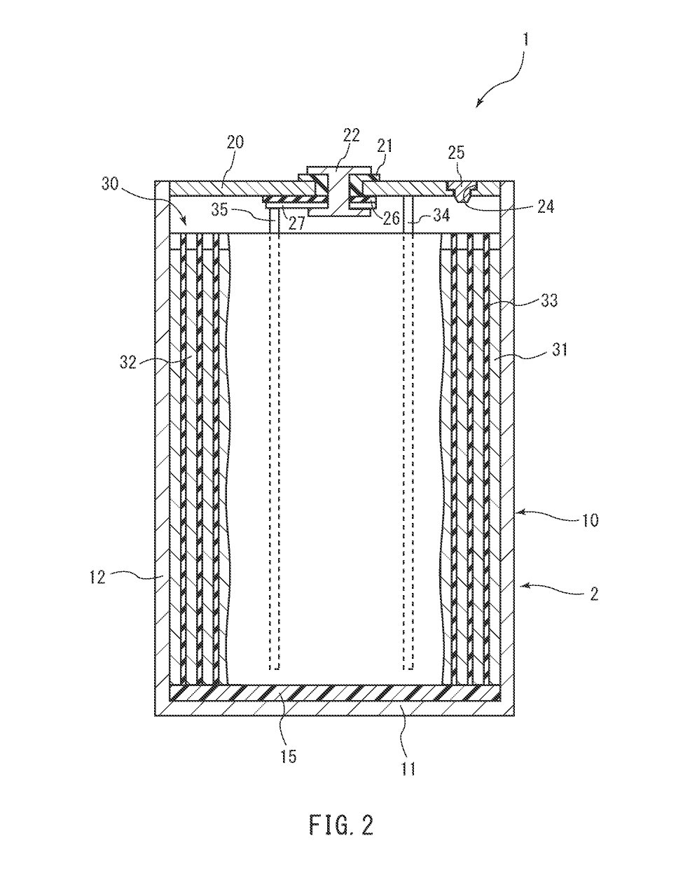

As shown in FIG. 2, the electrode assembly 30 is a jellyroll electrode assembly formed of a stacked and spirally wound sheet-shaped positive electrode 31 and negative electrode 32, where a separator 33 is placed between the two electrodes and one below the negative electrode 32, for example. The positive electrode 31, negative electrode 32 and separator 33 are all stacked upon one another and spirally wound before being pressed to form a flattened electrode assembly 30.

FIG. 2 only shows a few outer layers of the electrode assembly 30. An illustration of an inner portion of the electrode assembly 30 is omitted in FIG. 2; of course, the positive electrode 31, negative electrode 32 and separator 33 exist in the inner portion of the electrode assembly 30. Also, an illustration of an insulator or the like located in a space within the battery and near the cap 20 is omitted in FIG. 2.

The positive electrode 31 includes a positive current collector made of metal foil, such as aluminum foil, and a positive electrode active material layer containing positive electrode active material provided on both sides of the positive current collector. Specifically, the positive electrode 31 is fabricated by applying a positive electrode mixture containing a positive electrode active material, a conductive aid, a binder and the like to the positive current collector of aluminum foil or the like, the positive electrode active material being a lithium-containing oxide that can occlude and discharge lithium ions, and drying the applied materials. Preferably, lithium-containing oxides used as a positive electrode active material may include, for example, a lithium cobalt oxide such as LiCoO₂, a lithium manganese oxide such as LiMn₂O₄, or a lithium composite oxide including a lithium nickel oxide, such as LiNiO₂. It should be noted that just one positive electrode active material may be used, or two or more materials may be combined. Moreover, the positive electrode active materials are not limited to those mentioned above.

The negative electrode 32 includes a negative current collector made of metal foil, such as copper, and a negative electrode active material layer containing a negative electrode active material provided on both sides of the negative current collector. Specifically, the negative electrode 32 is fabricated by applying a negative electrode mixture containing a negative electrode active material, a conductive aid, a binder and the like to the negative current collector of copper foil or the like, the negative electrode active material being capable of occluding and discharging lithium ions, and drying the applied materials. Preferably, negative electrode active materials may include, for example, a carbon material that is capable of occluding and discharging lithium ions (graphites, pyrolytic carbons, cokes, glass-like carbons or the like). The negative electrode active materials are not limited to those mentioned above.

The positive electrode 31 of the electrode assembly 30 is connected with a positive lead 34, while the negative electrode 32 is connected with a negative lead 35. The positive and negative leads 34 and 35 extend to the outside of the electrode assembly 30. An end of the positive lead 34 is connected to the cap 20. An end of the negative lead 35 is connected to the negative terminal 22 via a lead plate 27, as described later.

The exterior can 10 is in the form of a cylinder with a bottom made of an aluminum alloy. The exterior can 10, together with the cap 20, forms the battery case 2. As shown in FIG. 1, the exterior can 10 is in the form of a cylinder with a bottom having a rectangular bottom 11 with arc-like short sides. More specifically, the exterior can 10 includes a bottom 11 and a flattened and cylindrical side wall 12 having a smooth and rounded surface. The side wall 12 includes a pair of opposite flat sections 13 (sides) and a pair of semi-cylindrical sections 14 connecting the flat sections 13. The exterior can 10 is in a flattened shape where the thickness, which corresponds to the dimension of the short sides of the bottom 11, is smaller than the width, which corresponds to the dimension of the long sides of the bottom 11 (for example, the thickness may be about one tenth of the width). Moreover, the exterior can 10 is joined to the cap 20 which is in turn connected to the positive lead 34, as described later. Thus, the external can 10 also serves as a positive electrode of the sealed battery 1.

As shown in FIG. 2, on the inside of the bottom of the exterior can 10 is placed an insulator 15 made of a polyethylene sheet for preventing a short circuit between the positive electrode 31 and the negative electrode 32 of the electrode assembly 30 via the exterior can 10. The electrode assembly 30 described above is positioned in such a way that one of its ends is on the insulator 15.

The cap 20 is joined to the opening of the exterior can 10 with welding to cover the opening of the exterior can 10. The cap 20 is made of an aluminum alloy, similar to the exterior can 10. The cap 20 has arc-like short sides of the rectangle such that it can fit with the inside of the opening of the exterior can 10. Further, the cap 20 has a through-hole in the center in its longitudinal direction. Through this through-hole pass an insulating packing 21 made of polypropylene and a negative terminal 22 made of stainless steel. Specifically, a generally cylindrical insulating packing 21 penetrated by a generally cylindrical negative terminal 22 fits with the periphery of the through-hole. The negative terminal 22 has flat portions integrally formed with the respective ends of the cylindrical axle. The negative terminal 22 is positioned relative to the insulating packing 21 such that a flat portion is exposed to the outside while the axle is inside the insulating packing 21. The negative terminal 22 is connected with a lead plate 27 made of stainless steel. Thus, the negative terminal 22 is electrically connected with the negative electrode 32 of the electrode assembly 30 via the lead plate 27 and the negative lead 35. An insulator 26 is placed between the lead plate 27 and the cap 20.

A fill port 24 for electrolyte is formed on the cap 20 next to the negative terminal 22. The fill port 24 is generally in the form of a circle in a plan view. The fill port 24 has a portion with a small radius and a portion with a large radius, where the radius changes in two steps as it goes in a thickness direction of the cap 20. The fill port 24 is sealed with a seal plug 25 formed in steps corresponding to the different radii of the fill port 24. The outer perimeter of the portion with a large radius of the seal plug 25 is laser-welded to the perimeter of the fill port 24 to prevent a gap from being produced between the seal plug 25 and the perimeter of the fill port 24.

(Vent)

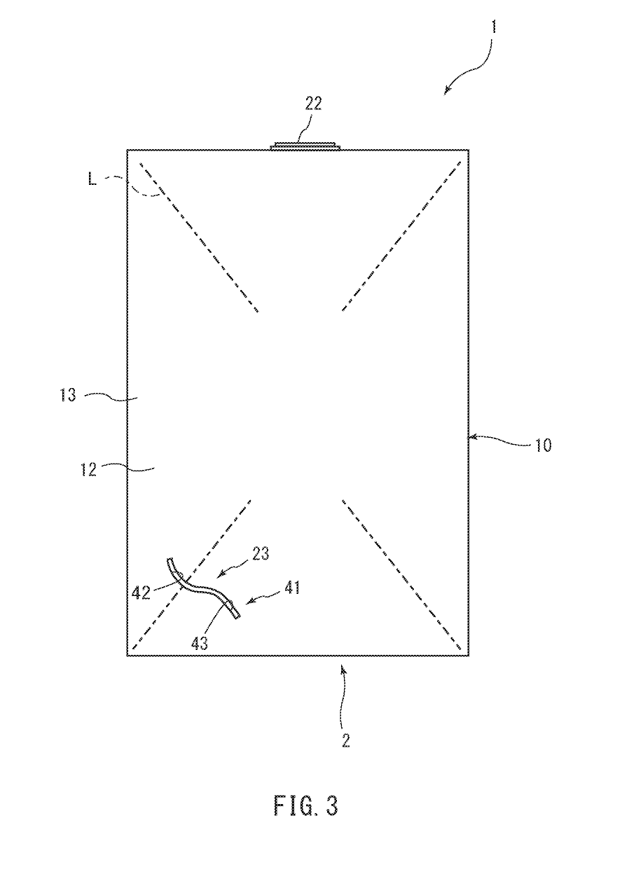

As shown in FIGS. 1 and 3, a cleavage groove 41 that constitutes a vent 23 is formed on a side of the exterior can 10. More particularly, a cleavage groove 41 that forms a generally S-shaped cleavage line is formed on a flat section 13, i.e. a portion of the side wall 12 of the exterior can 10 that extends in a width direction of the sealed battery 1. This cleavage groove 41 is configured to cleave up when the pressure in the battery case 2 exceeds a threshold.

As shown in FIG. 3, the cleavage groove 41 has a first curved segment 42 curved to protrude outward along the side (i.e. in one direction) as in a side view of the exterior can 10, and a second curved segment 43 curved to protrude inward along the side, i.e. in a direction opposite the outward direction. In this embodiment, the direction in which the first curved segment 42 protrudes (i.e. the direction in which the projection protrudes; the same shall apply hereinafter) and the direction in which the second curved segment 43 protrudes are at an angle of 180 degrees. The cleavage groove 41 forms a generally S-shaped cleavage line, as discussed above, where one end of the first curved segment 42 is connected with one end of the second curved segment 43. In other words, the cleavage line formed by the cleavage groove 41 is made up exclusively of a curved line with an inflexion point.

As the cleavage groove 41 is generally in a S-shape with the first curved segment 42 and second curved segment 43, as discussed above, the cleavage groove 41 can cleave up in response to a certain pressure in the battery case 2 more easily than a straight or arc-shaped cleavage line, as discussed below in more detail.

Further, since the cleavage groove 41 is generally S-shaped, the cleavage groove 41 may be formed in a smaller area than a straight or arc-shaped cleavage groove with the same length. Particularly, if the cleavage groove forms a straight line, the cleavage groove may cleave up in one stroke if there is an impact in a direction of an extension of this straight line. The above configuration will prevent the groove from rupturing from an impact in a particular direction. Thus, the cleavage groove 41 is unlikely to cleave up even when there is an impact on the battery case 2 during a fall or the like.

Further, in the present embodiment, portions of the flat section have a smaller thickness than other portions of the flat section 13 and thus form the cleavage groove 41. For example, the cleavage groove 41 is formed by pressing together with the exterior can 10 when the exterior can 10 is press-formed. Pressing causes work hardening in the portions of the flat section that surround the cleavage groove 41. This will improve the strength of the portions of the flat section surrounding the cleavage groove 41. Thus, even when there is an impact on the sealed battery 1 during a fall or the like, the cleavage groove 41 may be prevented from rupturing from the impact.

The cleavage groove 41 has a cross section in the shape of an inverted trapezoid, for example. More particularly, the cross section of the cleavage groove 41 is shaped as an inverted trapezoid with decreasing groove width as it goes toward the groove bottom. The cross section of the cleavage groove 41 may be shaped as a quadrangle other than a trapezoid, or may take other shapes such as triangles or ellipses.

Preferably, the cleavage groove 41 has a depth that produces a ratio of the remaining thickness of portions of the flat section 13 that have the groove relative to the plate thickness of the flat section (hereinafter referred to as “remaining thickness ratio”) of 75% or smaller, as discussed below. More preferably, the cleavage groove 41 has a depth that produces a remaining thickness ratio of 70% or smaller. Having a depth of the cleavage groove 41 that produces such a remaining thickness ratio will allow the cleavage groove 41 to cleave up in a more reliable manner in response to a certain pressure in the battery case 2 even with varying plate thickness of the flat section 13.

As shown in FIG. 3, the cleavage groove 41 is provided on one of the ridge lines L (indicated by broken lines in FIG. 3) formed on the exterior can 10 when the battery case 2 swells up due to an increase in interior pressure caused by an interior short circuit, for example, of the sealed battery 1. More specifically, in the present embodiment, the cleavage groove 41 is provided on the flat section 13 of the exterior can 10 such that the first curved segment 42 intersects the ridge line L. In addition, the cleavage groove 41 is provided on the flat section 13 such that the first curved segment 42 is curved to protrude toward a corner of the battery case 2 located at the base end of the ridge line L.

A ridge line L is formed as the battery case 2 swells up, causing portions of the flat section 13 of the exterior can 10 to bulge, drawn by peripheral portions of the battery case 2 (i.e. the four corners in a battery case 2 shaped as in the present embodiment). Thus, as indicated by one-dot chain lines in FIG. 3, ridge lines L extend inwardly from the four corners of the battery case 2 as in a side view of the battery case 2. In FIG. 3, straight ridge lines L extending inwardly from the four corners of the battery case 2 are formed. However, since the ridge lines are formed of bulging portions of the flat section 13 of the exterior can 10 formed when the battery case 2 swells up, as discussed above, the ridge lines L may be curved in shape, and some ridge lines L may be connected with each other.

A ridge line L is a portion of the exterior can 10 that receives large stresses when the battery case 2 swells up. As such, as discussed above, a cleavage groove 41 may be provided to intersect a ridge line L such that the cleavage groove 41 may easily cleave up as the exterior can 10 is deformed. More specifically, as the battery case 2 swells up, the flat section 13 of the exterior can 10 is drawn along ridge lines L such that the cleavage groove 41, which is a portion of the flat section 13 that has a smaller strength, cleaves up.

Particularly, as discussed above, the cleavage groove 41 may be provided on the flat section 13 in such a way that the first curved segment 42 is curved to protrude toward a corner of the battery case 2 located at the base end of a ridge line L such that the protrusion of the first curved segment 42 is located closer to the corner of the battery case 2. A ridge line L is generated beginning from a portion of the battery case 2 near a corner as the battery case 2 is deformed. Thus, the first curved segment 42 located on a ridge line L can cleave up relatively early during deformation of the battery case 2.

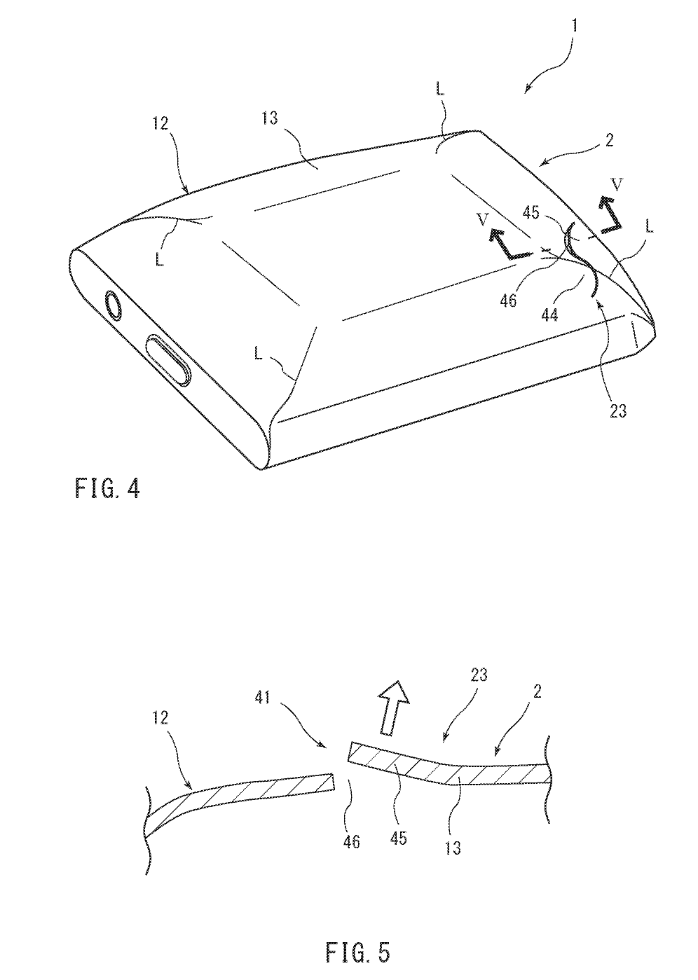

Thus, once a cleavage is generated at a portion of the cleavage groove 41 where the groove intersects a ridge line L, the cleavage advances along the cleavage groove 41. Thus, the entire cleavage groove 41 cleaves up. As the cleavage groove 41 cleaves up, generally semicircular tongues 44 and 45 are formed on the battery case 2, as shown in FIG. 4.

More specifically, when the pressure in the battery case 2 exceeds a threshold and the battery case 2 is deformed to cause the cleavage groove 41 to cleave up, the first curved segment 42 and second curved segment 43 of the cleavage groove 41 form tongues 44 and 45, respectively, on the battery case 2, as shown in FIG. 4. In other words, the tongues 44 and 45 are shaped according to the shape of the first curved segment 42 and second curved segment 43 of the cleavage groove 41 (i.e. generally semicircular in the present embodiment).

At this time, as shown in FIG. 5, the tongues 44 and 45 of the flat section 13 of the exterior can 10 are floating above other portions of the flat section 13 as the cleavage groove 41 cleaves up, thereby forming a gap 46. More specifically, when the cleavage groove 41 cleaves up and the flat section 13 of the exterior can 10 is slit up, portions of the flat section 13 along the ridge line L are drawn toward the corner of the exterior can 10 in such a way that portions closer to the corner are drawn outwardly to raise the tongues 44 and 45 relative to other portions of the side wall 12 (indicated by the hollow arrow in the drawing). The gap 46, formed between these tongues 44 and 45 and other portions of the flat section 13, releases gas or the like accumulated in the battery case 2 to the outside. In other words, portions of the flat section 13 that have the cleavage groove 41 serve as a vent 23.

In such a configuration, as the tongues 44 and 45 are raised, a cleavage forms an opening area larger than in implementations with a straight cleavage line. Thus, gas or the like in the battery case 2 can be effectively released to the outside.

Moreover, the tongues 44 and 45 formed by the cleavage of the cleavage groove 41 protrude in a thickness direction of the battery case 2, to the outside. This will prevent the tongues 44 and 45 from getting in contact with the electrode assembly 30 in the battery case 2, which would cause a short circuit.

In addition, in such a configuration, the size of the tongues formed by a cleavage is smaller than in implementations with a cleavage groove in a semicircular cleavage line with the same length as the cleavage groove 41. This will prevent the tongues 44 and 45 from contacting an exterior cladding film (not shown) covering the side wall 12 of the battery case 2. This will prevent tongues 44 and 45 in contact with the exterior cladding film from preventing a cleavage of the cleavage groove 41.

As shown in FIG. 3, the cleavage groove 41 is located in an area with a side of one half of a vertical dimension and a side of one half of a horizontal dimension of the flat section 13 with a corner at a corner of the battery case 2 located at the base end of the ridge line L, as viewed in a direction normal to the flat section 13. Thus, the cleavage groove 41 is provided closer to the base end of the ridge line L on the flat section 13. Thus, the cleavage groove 41 may cleave up in a more reliable manner as the flat section 13 is deformed.

More preferably, the cleavage groove 41 is located in an area with a side of one third of a vertical dimension and a side of one third of a horizontal dimension of the flat section 13 with a corner at a corner of the battery case 2 located at the base end of the ridge line L, as viewed in a direction normal to the flat section 13. Thus, the cleavage groove 41 is provided still closer to the base end of the ridge line L on the flat section 13. Thus, the cleavage groove 41 may cleave up in a still more reliable manner as the flat section 13 is deformed.

(Effects of Differences in Remaining Thickness Ratio of Cleavage Groove)

Next, the relationship between the ratio of the remaining thickness of the cleavage groove 41 (i.e. the remaining thickness of the flat section at the groove, see FIG. 7) relative to the plate thickness of the flat section 13 (see FIG. 7) (hereinafter referred to as “remaining thickness ratio) and the pressure at which the cleavage groove 41 cleaves up (i.e. the venting pressure) will be discussed using calculation results and other data.

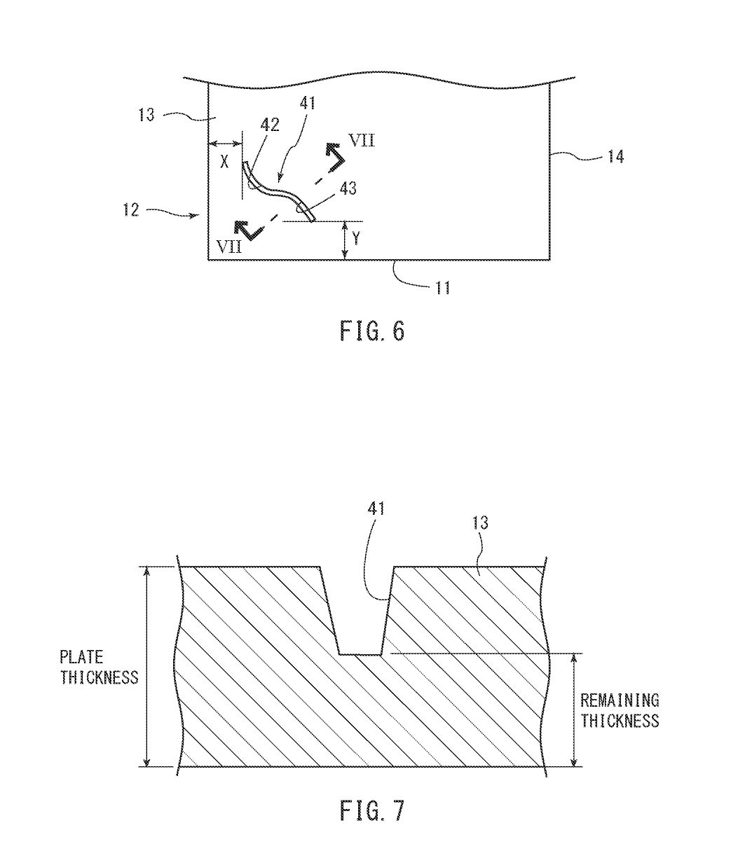

FIG. 6 schematically illustrates a portion of a calculation model used in the calculations described below. FIG. 6 shows a calculation model of a battery case 2 with a cleavage groove 41 forming a generally S-shaped cleavage line. As shown in FIG. 6, in the calculations below, the cleavage groove 41 is spaced apart (by X and Y in the drawing) from the semi-cylindrical section 14 side and the bottom 11 side of the flat section 13 of the battery case 2. In the calculations below, X=5 mm and Y=6 mm and the curvatures of the first curved segment 42 and second curved segment 43 of the cleavage groove 41 are represented as R=5 mm and 6 mm, respectively. The cross section of the cleavage groove 41 forms an inverted trapezoid where the width at the bottom is 0.03 mm and the angle formed by the sides of the groove is 20 degrees.

The calculations below used structural analysis software called LS-DYNA (Registered Trademark). In the calculations, the following equation for determining ductile fracture was used to determine whether the cleavage groove cleaved up (i.e. whether the battery was vented):

$$I = \frac{1}{b} {\int }_{0}^{ɛ} ( \frac{{σ}_{m}}{σ} + a ) d ɛ$$

Here, a and b are material parameters calculated from results of material tests. m represents average stress, equivalent stress, equivalent strain, and d increment in equivalent strain.

It will be assumed that rupturing begins at the cleavage groove when I exceeds 1 in the above equation, and the pressure in the battery case at that time will be referred to as venting pressure. In the present calculations, a is 0.3 and b is 0.14.

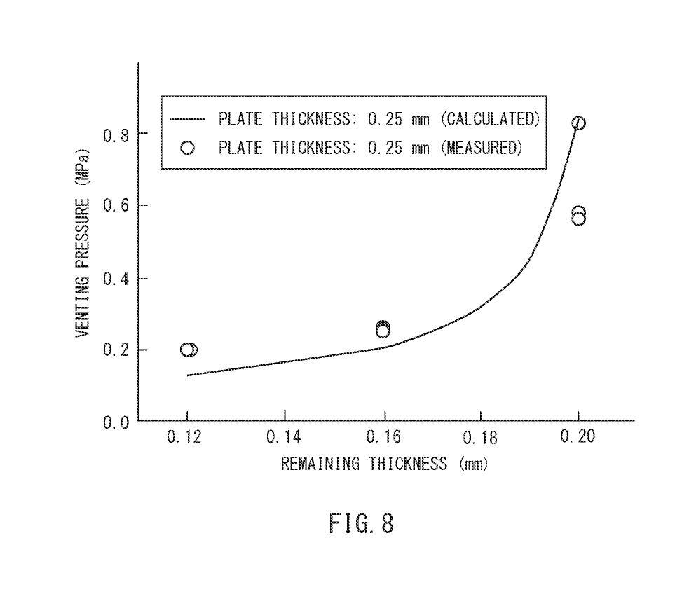

First, to determine whether the above-described calculation method used herein is appropriate, comparisons were made, in an arrangement with a cleavage groove 41 formed in a flat section 13 with a plate thickness of 0.25 mm, between values of venting pressure obtained by the above calculation method (i.e. calculation results) and values of venting pressure measured when a cleavage groove with the same shape at the same location as in the calculation model actually cleaved up (i.e. measurement results). The results of the comparisons are shown in FIG. 8. FIG. 8 shows measurement results for venting pressure of the cleavage groove with varying remaining thickness of the cleavage groove (indicated by white circles in the drawing) and calculation results (indicated by the solid line in the drawing). The battery case had a width of 44 mm, a height of 61 mm and a case thickness of 4.6 mm. To actually cause the cleavage groove to cleave up, air was injected into the battery case until the cleavage groove cleaved up, and the pressure in the battery case measured when rupturing occurred will be referred to as venting pressure.

As shown in FIG. 8, the measurement results and calculation results for venting pressure substantially match, and the calculations simulate the tendency of the measurement results for venting pressure to rapidly increase between the remaining thicknesses of the cleavage groove of 0.16 mm to 0.2 mm. Therefore, the calculation method used is capable of simulating actual situations. In the description below, the venting pressure that would be measured when a cleavage groove provided in battery cases with different sizes cleaves up will be obtained by calculation and, based on the results of the calculations, various remaining thickness ratios (remaining thickness ratio (%)=remaining thickness/plate thickness 100) will be evaluated.

FIG. 9 shows calculation examples for five battery cases 2 of different sizes. FIG. 9 illustrates the remaining thickness ratio versus the venting pressure. In FIG. 9, for Calculation Example 1, the battery case 2 has a width of 51 mm, a height of 56 mm and a case thickness of 4.6 mm, and the flat section 13 has a plate thickness of 0.25 mm. For Calculation Example 2, the battery case 2 has a width of 50 mm, a height of 59 mm and a case thickness of 5.3 mm, and the flat section 13 has a plate thickness of 0.27 mm. For Calculation Example 3, the battery case 2 has a width of 44 mm, a height of 61 mm and a case thickness of 4.6 mm, and the flat section 13 has a plate thickness of 0.25 mm. For Calculation Example 4, the battery case 2 has a width of 43 mm, a height of 50 mm and a case thickness of 4.8 mm, and the flat section 13 has a plate thickness of 0.25 mm. For Calculation Example 5, the battery case 2 has a width of 44 mm, a height of 61 mm and a case thickness of 4.8 mm, and the flat section 13 has a plate thickness of 0.28 mm.

FIG. 9 shows the calculation results of the five calculation examples for battery cases 2 with different sizes, using the ratio of the remaining thickness relative to the plate thickness of the flat section 13 of the battery case 2 (i.e. remaining thickness ratio) which would be measured at the cleavage groove 41. As shown in FIG. 9, even when the battery case has different sizes and the flat section 13 has different plate thicknesses, the venting pressure relative to the remaining thickness ratio exhibits a similar tendency. More particularly, the venting pressure increases as the remaining thickness ratio increases. Further, the amount of change in the venting pressure relative to the remaining thickness ratio (represented as the inclination of the lines in FIG. 9) for remaining thickness ratios of 75% and smaller (see the hatched arrow in the drawing) is significantly different from that for remaining thickness ratios of 75% and larger. More particularly, for remaining thickness ratios of 75% and smaller, the venting pressure does not change significantly as the remaining thickness ratio changes, while, for remaining thickness ratios of 75% and larger, the venting pressure changes significantly as the remaining thickness ratio changes. If the venting pressure changes significantly as the remaining thickness ratio changes, the venting pressure changes significantly if the remaining thickness ratio is slightly incorrect due to an error during machining or the like, meaning that the cleavage groove 41 may not cleave up in some cases.

Consequently, it is preferable that the cleavage groove 41 on the flat section 13 of the battery case 2 has a depth that produces a remaining thickness ratio of 75% or smaller, in which case the venting pressure will not change significantly even when the remaining thickness ratio is somewhat incorrect.

Further, as can be understood from FIG. 9, for remaining thickness ratios of 70% and smaller (see the hollow arrow in the drawing), the amount of change in the venting pressure relative to the remaining thickness ratio is even smaller than that for remaining thickness ratios in the range of 70% to 75%. Consequently, it is more preferable that the cleavage groove 41 provided on the flat section 13 of the battery case 2 has a depth that produces a remaining thickness ratio of 70% or smaller.

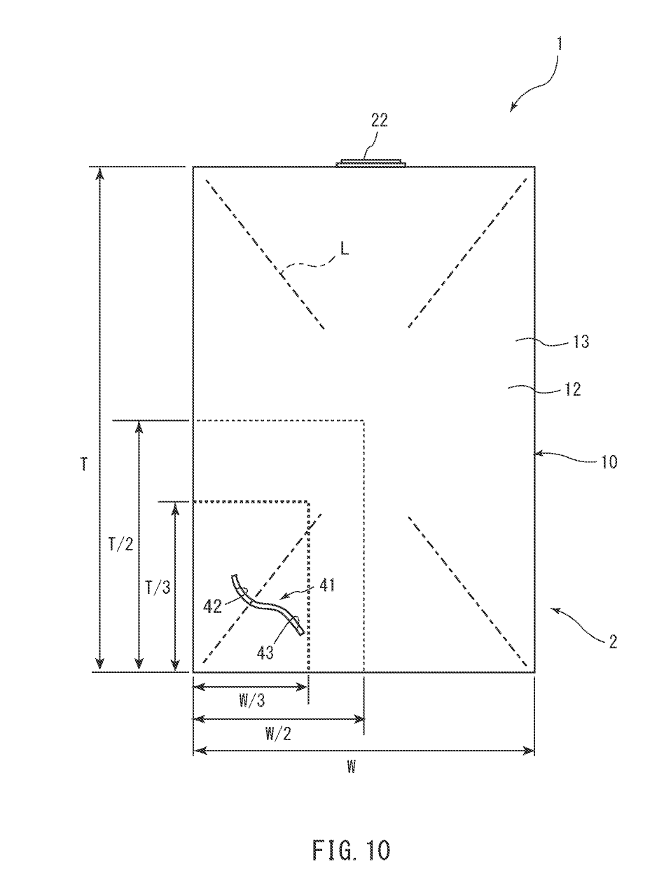

The above-described range of remaining thickness ratio (75% or smaller) is yet more preferable if, as shown in FIG. 10, the cleavage groove 41 is located in an area with a side of one half of a vertical dimension T and a side of one half of a horizontal dimension W of the flat section 13 with a corner at a corner of the battery case 2 located at the base end of the ridge line L (in an area defined by thin broken lines in FIG. 10), as viewed in a direction normal to the flat section 13. If the cleavage groove 41 is located in this area, the cleavage groove 41 can cleave up in a more reliable manner as the flat section 13 is deformed.

The above-described range of remaining thickness ratio (75% or smaller) is still more preferable if the cleavage groove 41 is located in an area with a side of one third of a vertical dimension T and a side of one third of a horizontal dimension W of the flat section 13 with a corner at a corner of the battery case 2 located at the base end of the ridge line L (in an area defined by thick broken lines in FIG. 10), as viewed in a direction normal to the flat section 13. If the cleavage groove 41 is located in this area, the cleavage groove 41 can cleave up in a still more reliable manner as the flat section 13 is deformed.

### Effects of Embodiment

Thus, in the present embodiment, a cleavage groove 41 is provided on a flat section 13 of a battery case 2 of a sealed battery 1, having a first curved segment 42 curved to protrude in one direction as in a side view and a second curved segment 43 curved to protrude in a direction opposite that one direction. This cleavage groove 41 has a depth that produces a ratio of the remaining thickness relative to the plate thickness of the flat section 13 (i.e. remaining thickness ratio) of 75% or smaller. Thus, the cleavage groove 41 can cleave up when the pressure is near the design value of venting pressure even if the depth of the cleavage groove 41 is somewhat different from its design value. Thus, the cleavage groove 41 can work in a more reliable manner.

Moreover, using the above-described remaining thickness ratio as a parameter, the relationship between remaining thickness ratio and venting pressure can be depicted by a graph as shown in FIG. 9 even when the battery case 2 has different sizes and the flat section 13 has different plate thicknesses. Thus, using the remaining thickness ratio as a parameter will make it possible to establish a depth of the cleavage groove 41 that can cleave up more reliably even when the battery case 2 has different sizes and the flat section 13 has different plate thicknesses.

Further, the cleavage groove 41 having a depth that produces a remaining thickness ratio of 70% or smaller will allow the cleavage groove 41 to cleave up still more reliably even when the groove depth is somewhat different from its design value.

### Other Embodiments

While an embodiment of the present invention has been illustrated, the above embodiment is merely an example that may be used to carry out the present invention. Thus, the present invention is not limited to the above embodiment, and the above embodiment may be modified as appropriate without departing from the spirit of the invention.

In the above embodiment, a cleavage groove 41 is provided such that the first curved segment 42 is located on a ridge line L. Alternatively, a cleavage groove 41 may be provided such that the second curved segment 43 is located on a ridge line L.

Further, the present invention is not limited to the configuration of the above embodiment, and the cleavage groove 41 may be located anywhere on the flat section 13 of the exterior can 10 as long as a portion of the cleavage groove 41 is located on a ridge line L, and the direction of the cleavage line formed by the cleavage groove 41 is not limited to the direction in the above embodiment.

In the above embodiment, the cleavage groove 41 has two curved segments 42 and 43. Alternatively, the cleavage groove may have three or more curved segments. In such implementations, the cleavage groove is suitably provided on the battery case 2 so as to form a cleavage line having curved segments being connected with each other, the curved segments each curved to protrude in a direction opposite that of the adjacent one(s).

In the above embodiment, the cleavage groove 41 is formed by pressing. Alternatively, the cleavage groove 41 may be formed by laser machining, cutting or the like.

In the above embodiment, the cleavage groove 41 is formed of a continuous groove. Alternatively, the cleavage groove may be divided into a plurality of segments, where several separate grooves constitute the cleavage groove 41.

In the above embodiment, the cleavage groove 41 has a first curved segment 42 curved to protrude outward along the side as in a side view of the exterior can 10 and a second curved segment 43 curved to protrude inward along the side, i.e. in a direction opposite the outward direction. However, the cleavage groove on the flat section 13 of the battery case 2 may be shaped such that the direction in which the first curved segment protrudes and the direction in which the second curved segment protrudes form an angle of about 90 degrees or larger. In other words, the cleavage groove may be in any shape as long as the direction in which the first curved segment protrudes and the direction in which the second curved segment protrudes form an angle of 90 degrees or larger.

In the above embodiment, the battery case 2 of the sealed battery 1 is shaped as a cylinder having a rectangular bottom surface with arc-shaped short sides. Alternatively, the battery case may be in another shape, such as a hexahedron.

In the above embodiment, the sealed battery 1 is a lithium-ion battery. Alternatively, the sealed battery 1 may be a battery other than a lithium-ion battery.

What is claimed is:

1. A sealed battery comprising a hollow and cylindrical battery case configured to encapsulate an electrode assembly and electrolyte,
wherein a side of the battery case includes a cleavage groove forming a cleavage line intersecting a ridge line which is formed on the side of the battery case when the battery case swells up due to an increase in internal pressure,
the cleavage line is formed exclusively of a curved line and formed of a first curved segment curved to protrude in one direction as viewed in a direction normal to the side of the battery case and a second curved segment curved to protrude in a direction forming an angle of 90 degrees or larger with the direction in which the first curved segment protrudes, the first and second curved segments being connected with each other,
an end of the first curved segment is connected with an end of the second curved segment,
at least one of the first curved segment and the second curved segment intersects the ridge line, and
the cleavage groove has a depth that produces a ratio of a remaining thickness relative to a plate thickness of the battery case of 75% or smaller.

2. The sealed battery according to claim 1, wherein
the cleavage groove has a depth that produces a ratio of the remaining thickness relative to the plate thickness of the battery case of 70% or smaller.

3. The sealed battery according to claim 1, wherein
the cleavage line is formed of a combination of a single first curved segment and a single second curved segment.

4. The sealed battery according to claim 1, wherein
the first curved segment is curved to protrude toward a corner of the battery case located at a base end of the ridge line, and
the cleavage groove is formed on the side of the battery case such that the first curved segment is located on the ridge line.

5. The sealed battery according to claim 1, wherein
the cleavage groove is formed on the side of the battery case to be located in an area with a side of one half of a vertical dimension and a side of one half of a horizontal dimension of the battery case with a corner at a corner of the battery case located at a base end of the ridge line, as viewed in a direction normal to the side of the battery case.

6. The sealed battery according to claim 1, wherein
the cleavage groove is formed on the side of the battery case to be located in an area with a side of one third of a vertical dimension and a side of one third of a horizontal dimension of the battery case with a corner at a corner of the battery case located at a base end of the ridge line, as viewed in a direction normal to the side of the battery case.
